(19) United States
(12) Patent Application Publication
(10) Pub. No.: US 2007/0158009 A1
(43) Pub. Date: Jul. 12, 2007

(54) Pneumatic tyre for two-wheeled vehicles

(76) Inventors: Fiorenzo Mariani, Biassono (IT); Mario Mariani, Milano (IT); Giancarlo Armellin, Nova Milanese (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/548,807

(22) PCT Filed: May 30, 2003
(86) PCT No.: PCT/IB03/02089

§ 371 Date: Jun. 15, 2006

(30) Foreign Application Priority Data
Mar. 26, 2003 (IB) PCT/IB03/01092

(51) Int. Cl. B60C 9/00

(52) U.S. Cl. 152/531; 152/532; 152/458; 152/560

(57) ABSTRACT

A pneumatic tyre for a two-wheeled vehicle includes at least one carcass ply. Each cord of the at least one carcass ply identifies a radial plane of the tyre passing through an intersection point of the cord with an equatorial plane of the tyre, and lies in a lying plane substantially perpendicular to the equatorial plane of the tyre and forming a lying angle different from zero with a respective radial plane. A pair of tyres each includes a predetermined rolling direction. The lying planes are oriented so that if the respective radial plane is fixed in position and the lying plane is rotated about the intersection point toward the respective radial plane through the lying angle, then the lying plane is superimposed on the respective radial plane and the direction of that rotation is the same as (front tyre) and the opposite of (rear tyre) the predetermined rolling direction.

The present invention relates to a pneumatic tyre particularly suitable for equipping two-wheeled vehicles.

It is known that a tyre generally comprises: a carcass structure provided with at least one carcass ply the ends of which are in engagement with respective circumferential annular reinforcing structures integrating annular elements usually called “bead cores”; a belt structure applied at a radially external position relative to the carcass structure, a pair of sidewalls applied at an axially external position to side surfaces of the carcass structure and each extending radially away from one of the annular anchoring structures towards said belt structure; a tread band currently consisting of a strip of elastomer material of appropriate thickness applied to the belt structure, at a radially external position and in which, following a moulding operation carried out concurrently with tyre vulcanisation, longitudinal and/or transverse grooves are formed that are disposed to define a desired “tread pattern”.

The carcass structure can be possibly coated on the inner walls thereof, with a so-called “liner” essentially consisting of an airtight layer of elastomer material that in tubeless tyres is adapted to ensure a hermetic seal of the tyre itself once it has been inflated.

In the so-called “radial” tyres each of the cords arranged in the carcass ply or plies lies in a plane substantially radial to the rotation axis of the tyre, i.e. it has an orientation substantially perpendicular to the circumferential extension direction.

In accordance with recent production processes, as described in document EP 928 680 in the name of the same Applicant for example, a pneumatic tyre can be directly built on a toroidal support. A first carcass ply is formed by laying a plurality of “strip-like elements” on said toroidal support, each strip-like element comprising longitudinal thread-like elements incorporated in a layer of elastomer material. Said strip-like elements are sequentially laid down so as to form a carcass structure in which the strip-like elements are partly overlapped at side portions of the tyre and disposed in circumferential side by side relationship with each other at the crown region of the tyre itself. Associated with the carcass ply are annular reinforcing structures for example comprising a first and a second circumferential annular inserts and an elastomer filler interposed therebetween. A second carcass ply can be made in superposed relationship with the first carcass ply and with said annular structures. Then a belt structure, also made by laying of strip-like elements, is associated with the carcass structure thus formed. Subsequently, a tread band and a pair of sidewalls are applied through superposition in coils disposed in axial side by side and/or radial superposed relationship, of an elementary semi-finished product of elastomer material in the form of an elongated element of suitable sizes. This process therefore contemplates use of at least two different types of elementary semi-finished products and more particularly: the elongated element, i.e. a section member of elastomer material alone and of substantially rectangular section; the strip-like element, i.e. a strip of elastomer material into which elongated reinforcing elements, typically textile or metallic cords are incorporated.

Document WO 00/38906 in the name of the same Applicant discloses a method of making a pneumatic tyre in which a carcass ply is formed by laying on a toroidal support, a first and a second series of sections alternated with each other and having side portions terminating on opposite sides relative to first primary portions of annular reinforcing structures to the beads. Subsequently, a second ply is formed in the same manner as the first ply, with a third and a fourth series of elongated sections superposed on opposite sides over second primary portions of the annular reinforcing structures. The sections forming the first and second carcass plies are laid in respective deposition planes parallelly offset on opposite sides relative to a meridian plane of the toroidal support, and have mutually-crossed side portions and radially-disposed crown portions.

As compared with tyres for four-wheeled vehicles, a quite particular performance involving many structural differences is required from tyres for two-wheeled vehicles. The most important differences result from the fact that during running on a bend a motorcycle must greatly incline relative to its position during running on a rectilinear stretch, forming an angle with the perpendicular to the ground (called “camber angle”) that usually reaches 45° but can even be as wide as 65° under extreme drive conditions. Therefore, when the motorcycle is running on a bend, the contact area of the tyre progressively moves from the central region of the tread to the axially outermost region in the direction of the bend centre. For this reason tyres for two-wheeled vehicles are distinguishable from the others due to the marked transverse curvature. This transverse curvature is usually defined by the particular value of the ratio of the distance between the radially outer point of the tread and the line passing by the laterally opposite extremities of the tread itself, measured on the equatorial plan of the tyre, to the distance measured along the tyre chord between said extremities. In tyres for two-wheeled vehicles, the value of the curvature ratio is generally at least as high as 0.15 and is currently in the order of about 0.3 for rear tyres and even higher, until about 0.45 for front tyres, against a value usually in the order of about 0.05 in the case of motor-vehicle tyres.

Presently, tyres for two-wheeled vehicles usually have a radial carcass structure associated with a belt structure that can comprise one or more belt layers shaped as a closed ring and essentially made up of textile or metallic cords suitably oriented relative to the cords belonging to the adjacent carcass structure.

In particular, the belt structure can be made of one or more continuous cords wound into coils that are disposed in axial side by side relationship and are substantially parallel to the circumferential extension direction of the tyre (the so-called “zero-degree belt”). Alternatively, the belt structure may consist of two radially superposed layers, each made up of elastomer material reinforced with cords disposed parallel to each other, said layers being such arranged that the cords of the first belt layer are oriented obliquely to the equatorial plane of the tyre, whereas the cords of the second layer have an oblique orientation as well, which however is symmetrically crossed with respect to the cords of the first layer (the so-called “crossed-belt”).

It is the Applicant's feeling that tyres for two-wheeled vehicles with crossed belt are characterised by a high bending rigidity in the region occupied by the tread band, which ensure an optimal behaviour on a bend. However, since the side rigidity at the sidewalls is relatively low as compared with the high bending rigidity in the region of the tread band, vibrations are likely to arise during running on a rectilinear stretch, which vibrations can reduce the vehicle stability at high speed.

On the contrary, in tyres for two-wheeled vehicles with a zero-degree belt, the bending rigidity at the tread band region is not substantially increased, so that during running on a rectilinear stretch, in particular at high speed, vibrations are controlled and gripping to the ground is improved. However, when a tyre is run on a bend the side rigidity may be insufficient and, in addition, in particular in the case of two-wheeled vehicles of big sizes, transmission of the torque onto the ground by the tyre may decrease.

In trying to combine an optimal behaviour during running both on a rectilinear stretch and on a bend, tyres for two-wheeled vehicles have been proposed in which the belt structure combines a zero-degree spiralling with a pair of crossed layers; see document GB 2 157 239, for example. These embodiments have seldom brought to a real balancing of the tyre behaviour, and at all events they involve a greater construction complexity and an important weight increase.

The Applicant has therefore felt the necessity to simplify the overall structure of the tyre, without on the other hand adversely affecting the behavioural features of same, maintaining ride comfort and stability substantially constant while reducing the weight. In addition, a simplified structure enables the building time to be reduced and, as a result, the production costs to be reduced as well.

The Applicant could ascertain that a carcass structure made with a single radial carcass ply makes the tyre structure lighter and simpler, but under some operating conditions, when high performance and high stability on a bend or on a rectilinear stretch are required from a tyre for example, the resulting tyre structure offers a poor performance above all with motorcycles of big sizes.

The Applicant has found that said problem can be solved by making a tyre having a carcass structure comprising at least one carcass ply in which each cord of said ply lies in a plane that is substantially perpendicular to the equatorial plane of the tyre and forms with the corresponding radial plane passing by the intersection point of said cord with the equatorial plane of the tyre, a lying angle different from zero. In this way the cords of the carcass ply are such arranged that they are submitted, during rolling of the tyre and as better illustrated in the following, to a force hindering deflection of the tyre itself.

A carcass ply thus made ensures accomplishment of a tyre with a carcass structure having a weight reduction even reaching 50%, the carcass rigidity being the same. Finally the tyre keeps excellent directional-stability qualities and a high capability of absorbing the disturbing energy resulting from ground unevennesses, thereby attenuating the so-called “kick-back” phenomenon.

As better illustrated in the following, this solution is particularly advantageous when the belt structure consists of one or more continuous cords spiralled along a direction substantially parallel to the equatorial plane of the tyre. In fact this belt structure enables the features of the carcass structure during running on a rectilinear stretch and on a bend to be enhanced as above illustrated, without making the overall structure of the tyre heavier.

In a first aspect, the present invention relates to a pneumatic tyre for two-wheeled vehicles comprising:
a carcass structure having at least one carcass ply, said carcass ply including a plurality of cords disposed substantially parallel to each other, said ply being shaped in a substantially toroidal configuration and having its ends in engagement with respective circumferential annular reinforcing structures;
a belt structure applied at a radially external position to said carcass structure;
a tread band applied at a radially external position to said belt structure;
a pair of sidewalls laterally applied on opposite sides relative to said carcass structure; wherein each cord of said carcass ply:
identifies a radial plane of said tyre passing by the intersection point of said cord with the equatorial plane of the tyre;
lies in a lying plane substantially perpendicular to the equatorial plane of the tyre and forming, with said radial plane, a lying angle different from zero.

According to a preferred embodiment, said belt structure comprises a layer having a plurality of circumferential coils disposed in axial side by side relationship and spirally wound with a substantially zero angle with respect to said equatorial plane of said tyre.

According to a further embodiment, in said carcass structure one carcass ply is provided.

According to a different embodiment of the tyre in reference, in said carcass structure provision is made for a first carcass ply and a further carcass half-ply associated with each other.

According to another preferred embodiment, said lying angle is included between about 1 and about 12 degrees.

In a further aspect, the invention relates to a pair of tyres for a two-wheeled vehicle, a front and a rear tyre respectively, each tyre comprising:
a carcass structure having at least one carcass ply, said carcass ply comprising a plurality of cords disposed substantially parallel to each other, said ply being shaped in a substantially toroidal configuration and having its ends in engagement with respective circumferential annular reinforcing structures;
a belt structure applied at a radially external position to said carcass structure;
a tread band applied at a radially external position to said belt structure;
a pair of sidewalls laterally applied on opposite sides relative to said carcass structure; wherein each cord of said carcass ply:
identifies a radial plane of said tyre passing by the intersection point of said cord with the equatorial plane of the tyre;
lies in a lying plane substantially perpendicular to the equatorial plane of the tyre and forming, with said radial plane, a lying angle different from zero; wherein each of said front and rear tyres has a predetermined rolling direction when mounted on said two-wheeled vehicle, so that:
in said front tyre said lying plane has such an orientation relative to said radial plane that said lying plane is superimposed on the radial plane sweeping said lying angle following a rotation around said intersection point of said cord with the equatorial plane of the tyre in the same direction as said predetermined rolling direction;
and in said rear tyre said lying plane has such an orientation relative to said radial plane that said lying plane is superimposed on the radial plane sweeping said lying angle following a rotation around said intersection point of said cord of the equatorial plane of the tyre in the opposite direction relative to said predetermined rolling direction.

Further features and advantages of the invention will become more apparent from the detailed description of some preferred, but not exclusive, embodiments of a tyre for two-wheeled vehicles in accordance with the present invention. This description will be set out hereinafter with reference to the accompanying drawings, given by way of non-limiting example, in which:

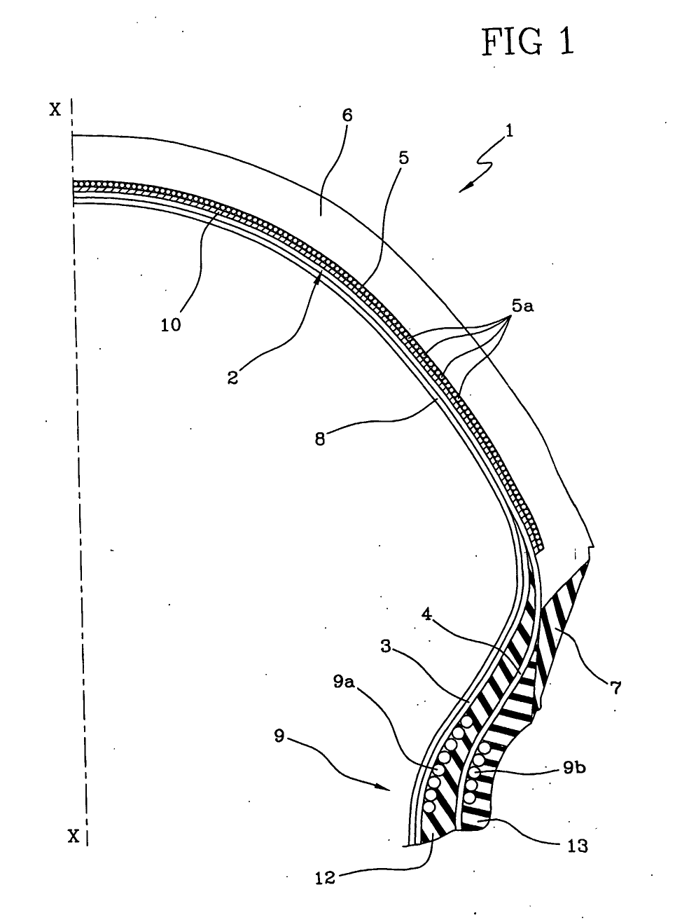

FIG. 1 is a partial cross-sectional view of a tyre in accordance with the invention;

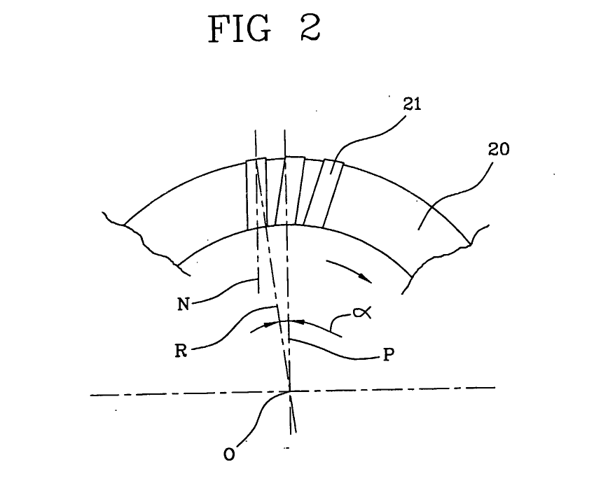

FIG. 2 is a partial side view of a portion of a carcass ply when the same is being made on a rigid toroidal support;

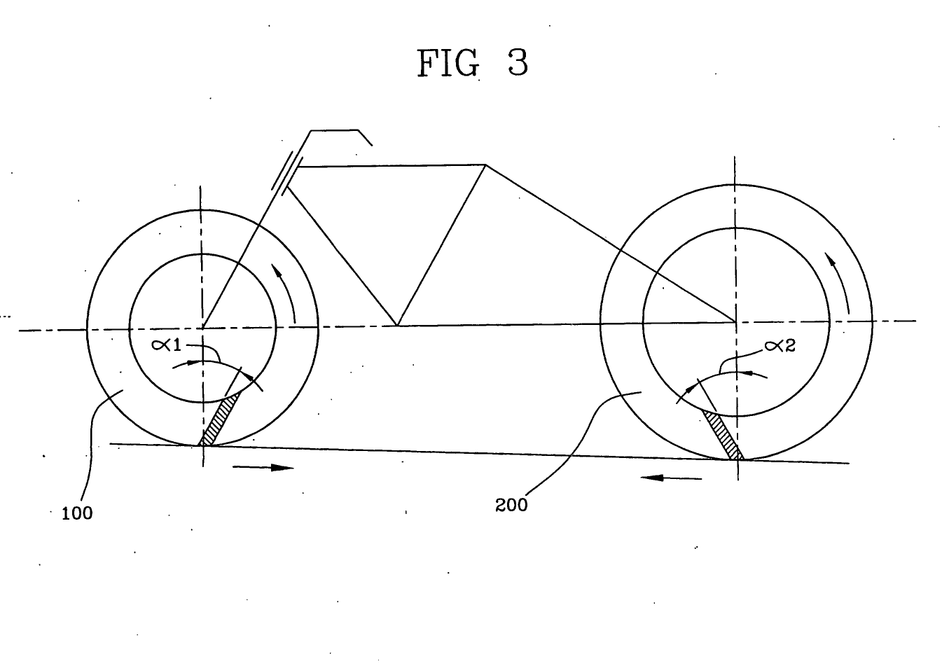

FIG. 3 is a diagrammatic side view of a two-wheeled vehicle employing one pair of tyres in accordance with the invention.

With reference to the drawings, a tyre for two-wheeled vehicles has been generally identified by reference numeral 1; it comprises a carcass structure including at least one carcass ply 2 preferably having a first and a second carcass half-plies 3, 4, said carcass ply 2 being shaped in a substantially toroidal configuration and being in engagement, by its opposite circumferential edges, with at least one annular reinforcing structure 9 so as to form a structure usually identified as “bead”.

Circumferentially applied to the carcass structure, at a radially external position, is a belt structure 5, on which a tread band 6 is circumferentially superposed, in said tread band longitudinal and transverse grooves being formed, by a moulding operation carried out concurrently with the tyre vulcanisation, which grooves are such arranged as to define a desired “tread pattern”.

Tyre 1 also comprises a pair of sidewalls 7 laterally applied on opposite sides to said carcass structure.

The carcass structure may possibly be coated on its inner walls with a so-called “liner”, essentially consisting of a layer of an air-tight elastomer material adapted to ensure a hermetic seal to the tyre itself once it has been inflated.

Preferably, the belt structure 5 comprises a layer that has a plurality of circumferential coils 5a disposed in axial side by side relationship and formed of a rubberized cord or a strip-like element including some rubberized cords (preferably 2 to 5), spirally wound with a substantially zero angle, with respect to the equatorial plane X-X of the tyre. In other words, said cords form a plurality of circumferential coils 5a substantially oriented towards the rolling direction of the tyre usually referred to as “0 degree” arrangement with reference to its position relative to the equatorial plane X-X of tyre 1.

In a preferred embodiment, the circumferential coils are wrapped on said carcass ply 2 with a variable pitch so as to preferably obtain a greater density of the cords on the opposite side portions than at the central portion of the belt structure 5.

It is to be pointed out here and in the following that even if the spiralling operation and any pitch variation can give rise to deposition angles different from zero, these angles are so small that they can be always considered as substantially equal to zero.

Generally said cords are textile or metallic cords. Preferably said cords are steel cords having such a behaviour that in a stress-strain diagram said cords have a percent elongation higher than 0.4%, more preferably included between 0.5 and 4%, with a load smaller than 5% relative to the breaking load.

Preferably said cords consist of high-carbon steel wires (HT), i.e. steel wires the carbon content of which is greater than 0.9%.

If textile cords are used, they can be made of a synthetic fibre, nylon, rayon, PEN, PET, for example, preferably a synthetic fibre having a high modulus, in particular an aramidic fibre (Kevlar® fibres, for example). Alternatively hybrid cords can be employed which comprise at least one low-modulus thread (a nylon or rayon thread, for example) twisted with at least one high-modulus thread (a Kevlar® thread, for example).

Optionally, tyre 1 may also comprise a layer 10 of elastomer material disposed between said carcass structure and belt structure 5 formed of said circumferential coils 5a, said layer 10 preferably extending over a surface substantially corresponding to the extension surface of said belt structure 5. Alternatively, said layer 10 extends on a smaller surface than the extension surface of the belt structure 5, only on opposite side surfaces thereof, for example.

In a further embodiment, an additional layer of elastomer material (not shown in FIG. 1) is disposed between said belt structure 5 formed of said circumferential coils 5a, and said tread band 6, said layer preferably extending over a surface substantially corresponding to the extension surface of said belt structure 5. Alternatively, said layer only extends along at least one portion of the extension of the belt structure 5, on opposite side surfaces thereof, for example.

In a preferred embodiment, at least one of said layer 10 and additional layer comprises short aramidic fibres, Kevlar® fibres for example, dispersed in said elastomer material.

Said carcass ply 2, as above illustrated, is preferably formed of two carcass half-plies 3, 4. Each of said half-plies 3, 4 has a plurality of cords oriented in such a manner that each of them crosses the equatorial plane of the tyre in accordance with the invention preferably at an angle substantially equal to 90°. In addition, the lying plane of each cord is substantially perpendicular to the equatorial plane X-X of said tyre 1, has an orientation relative to a radial plane R passing by the crossing point of said cord with the equatorial plane X-X, and forms an angle α with said radial plane R which is substantially different from 0° (lying angle).

Preferably, the carcass ply 2 is built in accordance with the process disclosed in the already mentioned document WO 00/38906. As shown in FIG. 2, a toroidal support 20 is used as the building drum, and a plurality of strip-like elements 21 is used as the constituent elements of said ply, each strip-like element having a plurality of cords parallel to each other and oriented in the longitudinal extension of the strip-like element itself. Each strip-like element 21 is laid on said toroidal support 20 in a lying plane N perpendicular to said equatorial plane X-X, and parallelly offset with respect to a radial plane “P” forming with said radial plane R, an angle equal to the lying angle α.

In this way each cord of the carcass ply crosses the equatorial plane X-X at a point belonging to a radial plane R of said tyre, each cord lying in a plane forming an angle α with said radial plane that is different from 0°.

Preferably, in the tyre in accordance with the invention said lying angle α is included between about 1 and about 12 degrees, more preferably between about 2 and about 8 degrees.

Said strip-like elements 21, as shown in FIG. 2, are preferably disposed side by side with respect to each other along the circumferential extension of said toroidal support 20, the interval between them being substantially the same as the transverse size of said strip-like elements. In this way, at the end of one rotation of the toroidal support 20 along its rotation axis which is substantially coincident with the rotation axis of the finished tyre, the first half-ply 3 is made. Subsequently in the same manner, by a subsequent rotation of the toroidal support 20, the second half-ply 4 is laid down.

Said deposition can be carried out by a single rotation of the toroidal support 20 thanks to a continuous side-by-side positioning of each strip-like element relative to the preceding one.

In principle, it is possible to make each carcass ply with a number of rotations greater than or equal to (as previously illustrated) two rotations of the toroidal support 20, each strip-like element being laid, with respect to the preceding one, with an interval in a circumferential direction corresponding to the number of said rotations less one, multiplied by the transverse size of said strip-like element.

Preferably the strip-like elements, of a width included between 5 mm and 20 mm, and of a thickness included between 0.5 mm and 2 mm, contain a number of cords of between 4 and 40, with a density preferably in the range of 60 to 180 cords/dm, measured on the carcass ply, in a circumferential direction, close to the equatorial plane of tyre 1.

The carcass ply in accordance with the present invention preferably comprises textile cords selected from those usually adopted when carcasses for tyres are manufactured, made of nylon, rayon, PET, PEN, for example, with a strand of a diameter included between 0.35 mm and 1.5 mm.

As an alternative to the strip-like elements, a single continuous cord can be used, which cord by an appropriate deposition consisting of successive side-by-side positionings on said toroidal support forms said carcass ply 2 with the same geometry. In this case therefore a plurality of cords in the strict sense of the word is no longer present, but there is a single cord having a plurality of stretches or segments from bead to bead which are joined to each other, each stretch being substantially equivalent to each cord belonging to the above illustrated strip-like element.

Therefore in the present description and in the following claims, by the term “plurality of cords” it is intended both a true multiplicity of cords and a plurality of stretches belonging to the same cord, substantially extending from bead to bead, that are joined together.

Preferably, each annular reinforcing structure 9 has at least one annular insert made of an elongated, preferably metallic, element disposed in substantially concentric coils, each coil being alternatively defined either by a stretch of a continuous spiral or by concentric rings formed of respective thread-like elements.

Preferably, as shown in FIG. 1, two annular inserts 9a and 9b are provided, the first of which is made when the first carcass half-ply 3 has been completed by winding up of said thread-like element with the possible aid of rollers or other appropriate devices acting against the action of the axially external surface of said half-ply 3 built on said toroidal support 20, as disclosed in said document WO 00/38906. The presence of a filler 12 of elastomer material is provided at a position axially external to said first annular insert 9a. When manufacture of the second half-ply 4 has been completed, said second annular insert 9b is made in the same manner as above. Deposition of a further filler 13 at a position axially external to said second annular insert 9b completes manufacture of said annular reinforcing structure 9.

The constituent material of said thread-like element can be any textile or metallic material or a material of other nature provided with appropriate features of mechanical resistance; preferably this material is standard or high-carbon steel preferably employed in the form of a metal cord.

In a different embodiment of the tyre in accordance with the invention a carcass structure is provided which has a first carcass ply associated with a further half-ply.

More specifically, subsequent to deposition of the liner and one possible filler of elastomer material, the first carcass ply is laid which may for example consist of two half-plies made in succession through two rotations of the toroidal support about an axis substantially coincident with the rolling axis of the finished tyre. Then a first annular insert, another filler of elastomer material, and a further carcass half-ply are laid in the described order. The strip-like elements of the last half-ply are preferably laid spaced out by a distance in a circumferential direction substantially corresponding to their transverse size; in addition each of them is substantially radially superposed on a corresponding strip-like element of the carcass ply already built on the toroidal support, i.e. the lying plane N will be the same.

Finally, a second annular insert and a further filler will complete building of the carcass structure.

In the same manner it is then possible to make a carcass structure having two carcass plies in which the second ply is built by superposing each strip-like element of the second ply on a strip-like element of the first ply in a substantially radial direction.

In a preferred embodiment, the mono-ply carcass structure or a carcass structure consisting of a ply and a half-ply, is coupled with a belt structure 5 only consisting of said coils 5a.

The tyre in accordance with the invention, employed on a two-wheeled vehicle both as a front tyre 100 and as a rear tyre 200 has a rotation direction of its own that must be coincident with the rotation due to the forward movement direction of the vehicle. For example, the vehicle diagrammatically shown in FIG. 3 provides for said rotation direction to be anticlockwise.

For what has been previously illustrated, it is to be pointed out that the lying plane of each cord with the radial plane passing by the intersection point of said cord with the equatorial plane X-X of the tyre determines said lying angle α. This, as can be seen from said FIG. 3, in a front tyre is of opposite sign with respect to that of a rear tyre. In particular, supposing that by a rigid rotation movement the lying plane is superimposed on the radial plane R sweeping said lying angle α, in the case of a front tyre 100 there will be a rotation in the same direction as the preestablished rotation direction of the tyre and in the case of a rear tyre 200, a rotation opposite to said rotation direction.

The applicant, without wishing to be bound to any interpretative theory, points out that this geometric difference, as better clarified in the following, substantially depends on the forces acting on said tyres as a consequence of the fact that the front wheel is a driven wheel, whereas the rear wheel is a driving wheel.

In more detail, the Applicant has noticed that in the case of the front tyre 100, the force tangent to tyre 100 at the contact point with the ground (force transmitted from the road to the tyre and directed in a direction opposite to the drive direction) gives rise on each cord in contact with the ground to a compression force that is an obstacle to deflection, so that tyre 100 increases its rigidity upon rolling on the ground. The rear tyre 200 is mounted, as previously noticed, in such a manner that it presents the lying angle α2 of each cord oriented in the opposite direction (FIG. 3). In this case the force tangent to tyre 200 at the contact point with the ground is the reaction force that the road transmits to the rear tyre 200 due to the force transmitted from tyre 200 to the road (driving wheel), which tangent force is directed in the running direction, i.e. in the opposite way with respect to the tangent force acting on the front tyre 100 (see arrows in FIG. 3): in order to obtain a compression force in this case too, the inclination of the lying plane of each cord must therefore be opposite to the inclination of the lying plane of the corresponding cord of the front tyre 100, i.e. the lying angles α1, α2 must be opposed to each other. Therefore tyres 100, 200 constituting a pair of tyres in accordance with the invention, must be mounted in such a manner as to present the inclination of each cord of the front tyre 100 in contact with the ground directed in the opposite direction with respect to the inclination of the corresponding cord of the rear tyre 200. Preferably this inclination corresponding to that of the lying plane substantially has the same absolute value in the pair of tyres in accordance with the invention.

1-21. (canceled)

22. A pneumatic tyre for a two-wheeled vehicle, comprising:
a carcass structure;
a belt structure;
a tread band; and
a pair of sidewalls;
wherein the carcass structure comprises:
at least one carcass ply;
wherein the at least one carcass ply comprises a plurality of cords disposed substantially parallel to each other,
wherein the at least one carcass ply is shaped in a substantially toroidal configuration,
wherein ends of the at least one carcass ply are engaged with respective circumferential annular reinforcing structures,
wherein the belt structure is disposed at a radially external position relative to the carcass structure,
wherein the tread band is disposed at a radially external position relative to the belt structure,
wherein the sidewalls are disposed on laterally opposite sides relative to the carcass structure, and
wherein each cord of the at least one carcass ply:
identifies a radial plane of the tyre passing through an intersection point of the cord with an equatorial plane of the tyre; and
lies in a lying plane substantially perpendicular to the equatorial plane of the tyre and forming a lying angle different from zero with a respective radial plane.

23. The tyre of claim 22, wherein each cord of the at least one carcass ply crosses the equatorial plane of the tyre, forming an angle of substantially 90° with respect to the equatorial plane of the tyre.

24. The tyre of claim 22, wherein the belt structure comprises:
a layer comprising a plurality of circumferential coils;
wherein the circumferential coils are disposed in axial side-by-side relationship, and
wherein the circumferential coils are spirally wound at a substantially zero-degree angle relative to the equatorial plane of the tyre.

25. The tyre of claim 24, wherein the circumferential coils comprise steel cords, and
wherein in a stress-deformation diagram, the steel cords demonstrate a behavior having a percent elongation greater than 0.4%, with a load lower than 5% with respect to a tensile strength of the steel cords.

26. The tyre of claim 25, wherein the percent elongation of the steel cords is greater than or equal to 0.5% and less than or equal to 4%.

27. The tyre of claim 22, wherein the carcass structure comprises only one carcass ply.

28. The tyre of claim 22, wherein the carcass structure comprises:
a first carcass ply; and
a carcass half-ply;
wherein the carcass half-ply is associated with the first carcass ply.

29. The tyre of claim 22, wherein a first layer of elastomer material is interposed between the carcass structure and the belt structure.

30. The tyre of claim 29, wherein the first layer comprises short aramidic fibres.

31. The tyre of claim 22, wherein a second layer of elastomer material is interposed between the belt structure and the tread band.

32. The tyre of claim 31, wherein the second layer comprises short aramidic fibres.

33. The tyre of claim 22, wherein a first layer of elastomer material is interposed between the carcass structure and the belt structure, and
wherein a second layer of elastomer material is interposed between the belt structure and the tread band.

34. The tyre of claim 33, wherein the first layer comprises short aramidic fibres, and
wherein the second layer comprises short aramidic fibres.

35. The tyre of claim 22, wherein the at least one carcass ply comprises a plurality of strip elements, and
wherein each strip element comprises at least one cord.

36. The tyre of claim 22, wherein each annular reinforcing structure comprises:
a first annular insert; and
a second annular insert;
wherein the first annular insert is axially external to a first carcass half-ply, and
wherein the second annular insert is axially external to a second carcass half-ply.

37. The tyre of claim 36, wherein each annular reinforcing structure comprises:
a first filler of elastomer material;
wherein the first filler of elastomeric material is axially external to the first annular insert.

38. The tyre of claim 36, wherein each annular reinforcing structure comprises:
a second filler of elastomer material;
wherein the second filler of elastomeric material is axially external to the second annular insert.

39. The tyre of claim 37, wherein each annular reinforcing structure further comprises:
a second filler of elastomer material;
wherein the second filler of elastomeric material is axially external to the second annular insert.

40. The tyre of claim 28, wherein each annular reinforcing structure comprises:
a first annular insert; and
a second annular insert;
wherein the first annular insert is axially external to the first carcass ply, and
wherein the second annular insert is axially external to the carcass half-ply.

41. The tyre of claim 22, wherein the tyre comprises a predetermined rolling direction,
wherein the tyre is designed to be mounted as a front tyre of the two-wheeled vehicle, and
wherein the lying plane is oriented so that if the respective radial plane is fixed in position and the lying plane is rotated about the intersection point of the cord with the equatorial plane of the tyre toward the respective radial plane through the lying angle, then the lying plane is superimposed on the respective radial plane and the direction of that rotation is the same as the predetermined rolling direction.

42. The tyre of claim 22, wherein the tyre comprises a predetermined rolling direction,
wherein the tyre is designed to be mounted as a rear tyre of the two-wheeled vehicle, and
wherein the lying plane is oriented so that if the respective radial plane is fixed in position and the lying plane is rotated about the intersection point of the cord with the equatorial plane of the tyre toward the respective radial plane through the lying angle, then the lying plane is superimposed on the respective radial plane and the direction of that rotation is the opposite of the predetermined rolling direction.

43. The tyre of claim 22, wherein the lying angle is greater than about 1 degree and less than about 12 degrees.

44. A pair of pneumatic tyres for a two-wheeled vehicle, comprising:
a front tyre; and
a rear tyre;
wherein each tyre comprises:
a carcass structure;
a belt structure;
a tread band; and
a pair of sidewalls;
wherein the carcass structure comprises:
at least one carcass ply;
wherein the at least one carcass ply comprises a plurality of cords disposed substantially parallel to each other,
wherein the at least one carcass ply is shaped in a substantially toroidal configuration,
wherein ends of the at least one carcass ply are engaged with respective circumferential annular reinforcing structures,
wherein the belt structure is disposed at a radially external position relative to the carcass structure,
wherein the tread band is disposed at a radially external position relative to the belt structure,
wherein the sidewalls are disposed on laterally opposite sides relative to the carcass structure,
wherein each cord of the at least one carcass ply:
identifies a radial plane of the tyre passing through an intersection point of the cord with an equatorial plane of the tyre; and
lies in a lying plane substantially perpendicular to the equatorial plane of the tyre and forming a lying angle different from zero with a respective radial plane,
wherein each tyre comprises a predetermined rolling direction,
wherein for the front tyre, the lying plane is oriented so that if the respective radial plane is fixed in position and the lying plane is rotated about the intersection point of the cord with the equatorial plane of the tyre toward the respective radial plane through the front tyre lying angle, then the lying plane is superimposed on the respective radial plane and the direction of that rotation is the same as the predetermined rolling direction, and
wherein for the rear tyre, the lying plane is oriented so that if the respective radial plane is fixed in position and the lying plane is rotated about the intersection point of the cord with the equatorial plane of the tyre toward the respective radial plane through the rear tyre lying angle, then the lying plane is superimposed on the respective radial plane and the direction of that rotation is the opposite of the predetermined rolling direction.

45. The pair of tyres of claim 44, wherein the front tyre lying angle has substantially a same magnitude as the rear tyre lying angle.
